(19) United States
(12) Patent Application Publication
(10) Pub. No.: US 2024/0212366 A1
(43) Pub. Date: Jun. 27, 2024

(54) DRUG IDENTIFICATION APPARATUS, DRUG IDENTIFICATION METHOD AND PROGRAM

(71) Applicant: FUJIFILM Toyama Chemical Co., Ltd., Tokyo (JP)

(72) Inventor: Shinji HANEDA, Tokyo (JP)

(73) Assignee: FUJIFILM Toyama Chemical Co., Ltd., Tokyo (JP)

(21) Appl. No.: 18/395,084

(22) Filed: Dec. 22, 2023

(30) Foreign Application Priority Data
Dec. 26, 2022 (JP) 2022-208697

(51) Int. Cl. G06V 20/60; G06V 30/18; G06V 30/19; G06V 30/24

(52) U.S. Cl. CPC G06V 20/60; G06V 30/18; G06V 30/19013; G06V 30/19173; G06V 30/248

(57) ABSTRACT

A drug identification apparatus determines which drug in the second-surface image of a package corresponds to a determined drug whose drug type has already been determined from the first-surface image which is an image of the other surface of the package, and present to a user, the determined drug and an undetermined drug in a second-surface image in such a manner that the determined drug and the undetermined drug may be differentiated from each other. Thus, the user may easily understand which drug needs the identification processing among the drugs in the second-surface image.

### CROSS-REFERENCE TO RELATED APPLICATION

The present application claims priority under 35 U.S.C § 119(a) to Japanese Patent Application No. 2022-208697 filed on Dec. 26, 2022, which is hereby expressly incorporated by reference, in its entirety, into the present application.

### BACKGROUND OF THE INVENTION

### Field of the Invention

The present disclosure relates to a drug identification apparatus, a drug identification method and a program, and particularly to an image processing technology that identifies a type of a drug from an image acquired by capturing the drug.

### Description of the Related Art

As one of technologies for increasing efficiencies of tasks such as discrimination of brought-in drugs and/or audit of preparation, an image processing technology for identifying a drug type from a captured image of a drug has been developed. Japanese Patent Application Laid-Open No. 2020-182525 discloses a drug discrimination method including: imaging, by a mobile terminal, a drug mounted on a mounting part of a drug imaging device; transmitting, by the mobile terminal, image data of the imaged drug to a server; and performing, by the server, discrimination processing on the drug in the image data transmitted from the mobile terminal based on correspondence data in which the image data of the drug and drug information are associated. According to Japanese Patent Application Laid-Open No. 2020-182525, a front surface and a back surface of the drug mounted on the mounting part can be imaged by using the mobile terminal from above and below the mounting part of the drug imaging device.

As another measure for acquiring image data of a front surface and a back surface of a drug, Japanese Patent Application Laid-Open No. 2020-182525 further discloses a method including: fixing the mobile terminal at an upper part or a lower part; imaging the front surface of the drug, then removing the mounting part from the drug imaging device; interchanging the front and the back of the drug within a dish part, then inserting the mounting part again to the drug imaging device; and imaging the back surface of the drug with the mobile terminal (Paragraph [0025] of Japanese Patent Application Laid-Open No. 2020-182525). In this case, when a plurality of drugs are in the dish part, if the position of the drugs is changed when interchanging the front and the back of the drugs, correspondence relationship between the image of the front surface and the image of the back surface of the drugs is broken. Since it is required to turn the drugs upside down while maintaining the positional relationship between the drugs, Patent Application Laid-Open No. 2020-182525 employs an embossed sheet in order to prevent displacement of the drug.

### CITATION LIST

Patent Literature 1: Japanese Patent Application Laid-Open No. 2020-182525

### SUMMARY OF THE INVENTION

An engraved mark or a print given on a drug is important information for identifying a drug. A drug having an engraved mark or a print thereon has a front side and a back side, and one or both of the front side and the back side may not have an enough amount of information for identifying the drug. For example, in a case where a surface on one side of a drug has only numerals engraved or printed thereon, it may be difficult to identify the drug only from the information. Also, in a case where a surface on one side of a drug is plain (no information engraved or printed thereon), it is difficult to identify a drug type from an image acquired by imaging the drug surface.

Preferably, a device for identifying drugs in a package is as small as possible in its size in consideration of portability and space saving. If the both sides of the drugs are concurrently imaged, it is easy to grasp a correspondence relationship between the front side and the back side of the drugs. However, in this case, a mechanism is required to image both sides of the drugs concurrently. As a result, the size of the device necessarily increases, and it is difficult to satisfy the demands. On the other hand, if the device is configured by one smartphone only or by a combination of a smartphone and a portable small platform, the demands for portability and space-saving can be satisfied. However, in this case, it is required to separately image each of the front side and the back side of the package of the drags.

In a case where one side of a package (unit-dose package, or one-dose package) in which drugs are accommodated in one packaging bag by one-dose packaging is imaged at each imaging, the front side or the back side of each drug in the packaging bag randomly exists in an image of the one side of the package imaged by the camera. Therefore, in order to complete identification of all drugs within one packaging bag by one imaging operation on one side of the packaging bag, the user is required to manually turn each drug over the packaging bag, so that a surface (drug identifiable surface) having an enough amount of information for drug identification thereon is directed to the camera side, before each imaging operation.

However, in a case where a large number of drugs are included in a packaging bag, it is troublesome and difficult to manually turn drugs so that the drug identifiable surfaces of all of the drugs are directed to the camera side. Accordingly, another technique may be considered in which the front surface and the back surface of one package are imaged one by one, and one image including the drug identifiable surface of the two images of both the front surface and the back surface are used to identify each drug in the captured images.

However, even with this technique, since the drugs may be moved within the packaging bag when the package is inverted, correspondence relationships among drugs are ambiguous between two images of a first-surface image acquired by imaging a first surface of a packaging bag and a second-surface image acquired by imaging a second surface after the inversion of the package. As a result, it may be difficult to judge which drug in the second-surface image after the inversion, is corresponding to the drug (identified drug) whose drug type has already been determined from the first-surface image.

Particularly, in a case where the number of drugs is large, it is difficult for a user to remember identified drugs whose drug types have already been determined by using the first-surface image. Therefore, high burden is imposed on the user in the system that requires the user himself/herself to distinguish between remaining drugs to be identified in the second-surface image and the identified drugs.

The present disclosure has been made in view of such a circumstance, and aims to provide a drug identification apparatus, a drug identification method, and a program that can present which drug on a second-surface image corresponds to a drug whose drug type has been determined using a first-surface image.

A drug identification apparatus according to a first aspect of the present disclosure includes one or more processors; and one or more storage devices, wherein the one or more storage devices are configured to store an identification mark master including an image of an identification mark on each of a front surface and a back surface, for each drug having the identification mark formed by engraving or printing thereon, and wherein the one or more processors are configured to: detect each drug, from a first-surface image acquired by imaging a first surface of a package (one dose package, or unit dose package) accommodating drugs in a packaging bag; create, from the identification mark master by using information on a determined drug which is at least one of the drugs, and whose drug type and a front surface and a back surface have been determined based on a drug image extracted for each drug from the first-surface image, a second-surface ground-truth identification mark image list including an identification mark image showing an identification mark of the determined drug appearing on a second surface being a back surface of the first surface of the package; detect each drugs from a second-surface image acquired by imaging the second surface of the package; extract an identification mark of each drug from the second-surface image, and create an extracted identification-mark image list including an extracted identification-mark image for each drug; determine the determined drug in the second-surface image by performing pattern matching using the second-surface ground-truth identification mark image list and the extracted identification-mark image list; and present on the second-surface image, information for differentiating the determined drug from a undetermined drug whose drug type has not been determined.

In the first aspect, the one or more processors can automatically determine which drug in the second-surface image corresponds to the determined drug whose drug type has been determined from the first-surface image, and can present to a user drugs in the second-surface image in such a manner that the determined drug whose drug type has been determined from the first-surface image is clearly differentiated from an undetermined drug whose drug type has not been determined. Thus, the user may easily understand the identification target drug which is a drug on which drug identification processing is to be performed, in the second-surface image. Thus, the drug identification work on the package may be performed more efficiently.

The identification mark may be, for example, an identification code including a combination of a company code and a product code, or including one of a company code and a product code.

The determination of a drug type of a drug may be determination of an individual brand of a drug. The drug type to be determined may be an individual identification code of a drug as typified by a YJ code, for example. The fact that “the drug type of a drug has been determined” means that “the drug has been identified”. As to the definitions of the front and back of a drug, a drug-identifiable surface may be defined as the front, and a surface on the other side may be the back, for example. Here, the drug-identifiable surface means a surface having an identification mark which is formed by engraving or printing thereon and from which the drug can be identified. Further, generally, while a designed engraved mark or print on both of the surfaces are illustrated horizontally or vertically side by side on an attached document that is an official document, the surface having an engraved mark or print illustrated at the left or upper part in the attached document may be defined as the front, and an engraved mark or print illustrated at the right or lower part may be defined as the back. In a case where each of the both surfaces of a drug is a drug-identifiable surface, either one may be defined as the front.

A drug identification apparatus according to a second aspect may be the drug identification apparatus according to the first aspect, wherein the one or more processors may be configured to identify the drug type and the front surface and the back surface for the at least one of the drugs, using a drug identification model trained by machine learning to identify a drug type and a front surface and a back surface from the drug image.

A drug identification apparatus according to a third aspect may be the drug identification apparatus according to the first aspect, wherein the one or more processors may be configured to: identify the drug type for the at least one of the drugs, using a drug identification model trained by machine learning to identify a drug type from the drug image; and determine the front surface and the back surface for the at least one of the drugs, using the identification mark master.

A drug identification apparatus according to a fourth aspect may be the drug identification apparatus according to the third aspect, wherein the one or more processors may be configured to determine a front surface and a back surface by pattern matching between the drug image or an identification mark image extracted from the drug image, and the identification mark master.

A drug identification apparatus according to a fifth aspect may be the drug identification apparatus according to any one aspect of the first to fourth aspects, wherein the one or more processors may be configured to: perform round-robin pattern matching between the identification mark images in the second-surface ground-truth identification mark image list and the extracted identification-mark images in the extracted identification-mark image list; and determine the determined drug in the second-surface image based on a matching score.

A drug identification apparatus according to a sixth aspect may be the drug identification apparatus according to any one aspect of the first to fifth aspects, wherein the pattern matching may be template matching.

A drug identification apparatus according to a seventh aspect may be the drug identification apparatus according to the any one aspect of the first to sixth aspects, wherein the one or more processors may be configured to: receive input of an instruction to confirm the drug type identified for the at least one of the drugs; and determine the drug type of a target drug based on the input of the instruction.

A drug identification apparatus according to an eighth aspect may be the drug identification apparatus according to any one aspect of the first to seventh aspects, wherein the one or more processors may be configured to create a determined list as information on the determined drug.

A drug identification apparatus according to a ninth aspect may be the drug identification apparatus according to any one aspect of the first to eighth aspects, wherein the one or more processors may be configured to add to the determined drug in the second-surface image, a mark as the information for differentiating so as to present that its drug type has been determined.

A drug identification apparatus according to a tenth aspect may be the drug identification apparatus according to any one aspect of the first to ninth aspects, wherein the one or more processors may be configured to add to the undetermined drug in the second-surface image, a mark as the information for differentiating so as to present that its drug type has not been determined.

A drug identification apparatus according to an eleventh aspect may be the drug identification apparatus according to any one aspect of the first to tenth aspects, further including a display configured to display the second-surface image including the information for differentiating.

A drug identification apparatus according to a twelfth aspect may be the drug identification apparatus according to any one aspect of the first to eleventh aspects, further including a camera configured to image the package.

A drug identification method according to a thirteenth aspect of the present disclosure is a method to be executed by one or more processors, the method including: causing, in advance, one or more storage devices to store an identification mark master including an image of an identification mark on each of a front surface and a back surface, for each drug having the identification mark formed by engraving or printing thereon; acquiring a first-surface image acquired by imaging a first surface of a package accommodating drugs in a packaging bag; detecting each drug from the first-surface image and extracting a drug image for each drug; determining a drug type and a front surface and a back surface for at least one of the drugs based on the drug image extracted from the first-surface image; creating, from the identification mark master by using information on a determined drug whose drug type has been determined from the first-surface image, a second-surface ground-truth identification mark image list including an identification mark image showing an identification mark of the determined drug appearing on a second surface being a back surface of the first surface of the package; acquiring a second-surface image by imaging the second surface of the package; detecting each drug from the second-surface image to extract an identification mark of each drug, and creating an extracted identification-mark image list including an extracted identification-mark image for each drug; determining the determined drug in the second-surface image by performing pattern matching using the second-surface ground-truth identification mark image list and the extracted identification-mark image list; and presenting on the second-surface image, information for differentiating the determined drug from a undetermined drug whose drug type has not been determined.

The drug identification method according to the thirteenth aspect may be configured to include specific aspects similar to those of the drug identification apparatus according to any one aspect of the second to twelfth aspects.

A program according to a fourteenth aspect of the present disclosure is a program for causing a computer to implement the drug identification method according to the thirteenth aspect. A tangible, non-transitory and computer-readable recording medium which (computer-readable medium) records the program according to the fourteenth aspect is also included in the present disclosure.

The program according to the fourteenth aspect may be configured to include specific aspects similar to those of the drug identification apparatus according to any one aspect of the second to twelfth aspects.

According to the present disclosure, one or more processors execute processing of determining which drug in the second-surface image corresponds to the determined drug whose drug type has already been determined from the first-surface image of a package, and present to a user, the determined drug and an undetermined drug in a second-surface image in such a manner that the determined drug and the undetermined drug may be differentiated from each other. Thus, the user may easily understand which drug needs the identification processing among the drugs in the second-surface image.

### BRIEF DESCRIPTION OF THE DRAWINGS

FIG. 1 is a front perspective view of a smartphone;

FIG. 2 is a back perspective view of the smartphone;

FIG. 3 is a block diagram showing an electrical configuration of the smartphone;

FIG. 4 is a block diagram showing a functional configuration of a drug identification apparatus according to an embodiment;

FIG. 5 shows an example of a first-surface image acquired by imaging a first surface of a package;

FIG. 6 is an explanatory diagram showing an example of an engraved-mark image included in an engraved-mark master;

FIG. 7 is an explanatory diagram showing an example of a case where an engraved-mark image on a second surface side of a determined drug is determined from an engraved-mark master;

FIG. 8 is an explanatory diagram showing an example of a second-surface ground-truth engraved-mark image list;

FIG. 9 shows an example of a second-surface image acquired by imaging a second side of a package;

FIG. 10 is an explanatory diagram showing a processing example of template matching by using a second-surface ground-truth engraved-mark image list and a second-surface extracted engraved-mark image list;

FIG. 11 is an explanatory diagram showing a presentation example of information for differentiating determined drugs from undetermined drugs on a second-surface image; and

FIG. 12 is a flowchart showing an example of a drug identification method implemented by using a drug identification apparatus according to an embodiment.

### DESCRIPTION OF THE PREFERRED EMBODIMENTS

Preferred embodiments of the present invention are described in detail below with reference to attached drawings.

### Outline of Drug Identification Apparatus According to Embodiment

A drug identification apparatus according to an embodiment of the present disclosure is an information processing apparatus that performs processing of identifying individual drug types of drugs accommodated in a packaging bag by one-dose packaging using a first-surface image and a second-surface image acquired by respectively imaging a first surface being a surface on one side of the packaging bag and a second surface on a back side thereof, while keeping the drugs within the packaging bag.

The drug identification apparatus according to the embodiment follows the steps of firstly determining drug types of at least some of drugs shown on the first-surface image, and then identifying remaining drugs by using the second-surface image. The drug identification apparatus according to the embodiment includes one or more processors, and the one or more processors are configured to automatically determine which drug on the second-surface image corresponds to the determined drug whose drug type has been determined from the first-surface image, and perform processing of presenting to a user, a screen displaying the second-surface image in such a manner that the drug whose drug type has already been determined from the first-surface image is clearly differentiated from an undetermined drug whose drug type has not been determined yet (that is, the remaining drugs to be identified on the second-surface image). Thus, a user can easily understand drug for which drug type identification is to be performed on the second-surface image so as to improve efficiency of drug identification work on a package.

The term, “identification” used for a drug embraces concepts of discrimination and audit. The type of a drug to be identified is a drug type that can be determined based on an identification information, for example, YJ code (individual drug code), a drug name, or the like. The drug identification according to the embodiment may be defined as an action that determines a YJ code corresponding to the identification target drug. This is just an example of the definition of the drug identification. For example, an identification code may be defined by a code type other than YJ code. The determined drug whose drug type has been determined may also be referred to as an “identified drug”.

The drug identification apparatus is, for an example, installed in a mobile terminal apparatus. For an example, the mobile terminal apparatus includes at least one of a smartphone, a mobile phone, a personal handy-phone system (PHS), a personal digital assistant (PDA), a tablet type computer terminal, a notebook type personal computer terminal, a wearable terminal, and a mobile game machine. Hereinafter, a drug identification apparatus implemented by hardware and software of a smartphone is exemplarily described in detail with reference to drawings.

### Appearance of Smartphone

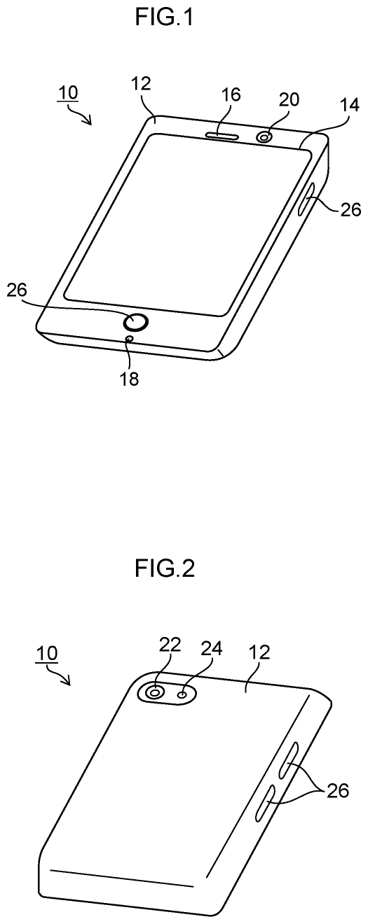

FIG. 1 is a front perspective view of a smartphone 10 functioning as a drug identification apparatus according to an embodiment of the present disclosure. As shown in FIG. 1, the smartphone 10 has a planer housing 12. The smartphone 10 includes a touch panel display 14, a speaker 16, a microphone 18, and an in-camera 20 on a front side of the housing 12.

The touch panel display 14 includes: a display unit configured to display an image and the like; and a touch panel unit which is arranged on a front surface of the display unit and configured to receive a touch input. The display unit may be, for example, a color liquid crystal display (LCD) panel or a color organic electro-luminescence (EL) panel.

For example, the touch panel unit is planarly provided on a substrate body having light transmission, and is a capacitive touch panel including: position detection electrodes with light transmission; and an insulating layer provided on position detection electrodes. The touch panel unit is configured to generate and output two-dimensional positional coordinates information corresponding to a user's touch operation. Examples of the touch operation include a tap operation, a double-tap operation, a flick operation, a swipe operation, a drag operation, a pinch-in operation, and a pinch-out operation.

The speaker 16 is a sound output unit configured to output voice and sound while talking and playing movie. The microphone 18 is a sound input unit configured to receive input of voice and sound while talking and capturing a moving image. The in-camera 20 is an imaging device configured to capture a moving image and a still image.

FIG. 2 is a back perspective view of the smartphone 10. As shown in FIG. 2, the smartphone 10 includes an out-camera 22 and a light 24 on a back surface of the housing 12. The out-camera 22 is an imaging device configured to capture a moving image and a still image. The light 24 is a light source configured to radiate illuminating light when capturing image with the out-camera 22. The light 24 is configured by, for example, a light emitting diode (LED).

Further, as shown in FIGS. 1 and 2, the smartphone 10 includes switches 26 on front and side surfaces of the housing 12 respectively. Each switch 26 is an input member configured to receive an instruction from a user. Each switch 26 is a push-button type switch configured to be turned on when pressed with a finger or the like, and be turned off when the finger is detached from the switch due to the resilience of a spring or the like therein.

Note that the configuration of the housing 12 is not limited to the example. The housing 12 may have a configuration having a collapsible structure or a slide mechanism.

### Electrical Configuration of Smartphone

The smartphone 10 may include a wireless communication function for performing mobile wireless communication via base station devices and a mobile communication network.

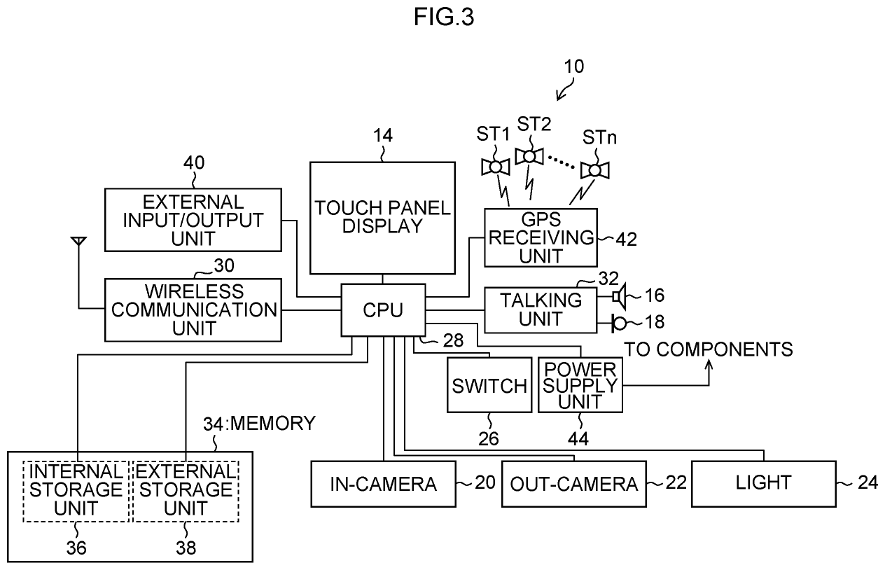

FIG. 3 is a block diagram showing an electrical configuration of the smartphone 10. As shown in FIG. 3, the smartphone 10 includes a central processing unit (CPU) 28, a wireless communication unit 30, a talking unit 32, a memory 34, an external input/output unit 40, a GPS (global positioning system) receiving unit 42, and a power supply unit 44, in addition to the touch panel display 14, speaker 16, microphone 18, in-camera 20, out-camera 22, light 24, and switches 26 described above.

The CPU 28 is an example of a processor configured to execute an instruction stored in the memory 34. The CPU 28 is configured to operate in accordance with a control program and control data stored in the memory 34, and integrally controls components of the smartphone 10. The CPU 28 includes a mobile communication control function for controlling communication-related components and application processing function for performing voice communication and data communication through the wireless communication unit 30.

The CPU 28 further includes an image processing function for displaying a moving image, a still image, text and the like on the touch panel display 14. With the image processing function, information such as a still image, a moving image, text and the like is visually conveyed to a user. The CPU 28 is further configured to acquire two-dimensional positional coordinates information corresponding to a user's touch operation through the touch panel unit of the touch panel display 14. The CPU 28 is further configured to acquire an input signal from the switch 26.

Each of the in-camera 20 and the out-camera 22 includes an imaging lens, a diaphragm, an imaging device, an analog face end (AFE), an analog to digital (A/D) converter, a lens driving unit, and the like, not shown. The in-camera 20 and out-camera 22 are configured to capture a moving image and a still image in accordance with an instruction from the CPU 28.

The CPU 28 may convert the moving image and the still image captured by the in-camera 20 and the out-camera 22 to compressed image data such as Moving Picture Experts Group (MPEG) data and Joint Photographic Experts Group (JPEG) data.

The CPU 28 is configured to records the moving image and the still image captured by the in-camera 20 and out-camera 22, in the memory 34. The CPU 28 may be further configured to output the moving image and the still image captured by the in-camera 20 and out-camera 22 externally to the smartphone 10 through the wireless communication unit 30 or the external input/output unit 40.

The CPU 28 is further configured to display the moving image and the still image captured by the in-camera 20 and out-camera 22 on the touch panel display 14. The CPU 28 may be configured to utilize the moving image and the still image captured by the in-camera 20 and out-camera 22 within application software.

Note that the CPU 28 may be configured to turn on the light 24 to radiate fill-in light for imaging, to a subject when imaging the subject by the out-camera 22. The turning on and off of the light 24 may be controlled in response to a touch operation on the touch panel display 14 or an operation on the switch 26 by a user.

The wireless communication unit 30 is configured to perform wireless communication with base station devices corresponding to the mobile communication network based on 4th generation (4G) or 5th generation (5G) standard or the like in accordance with an instruction from the CPU 28. The smartphone 10 is configured to use the wireless communication to transmit and receive various file data such as sound data and image data and e-mail data and the like, and receive World Wide Web (abbreviated to “Web”) data, streaming data and the like.

The speaker 16 and the microphone 18 are connected to the talking unit 32. The talking unit 32 is configured to decode sound data received through the wireless communication unit 30 and output the decoded data through the speaker 16. The talking unit 32 is configured to convert user's voice input through the microphone 18 to sound data that is processable by the CPU 28 and output the converted data to the CPU 28.

The memory 34 is configured to store instructions to be executed by the CPU 28. The memory 34 includes an internal storage unit 36 internally provided in the smartphone 10 and an external storage unit 38 removably provided in the smartphone 10. The internal storage unit 36 and the external storage unit 38 are implemented by using publicly known storage media.

The memory 34 is configured to store a control program for the CPU 28, control data, application software, address data in which a name, a telephone number and the like of the other communication party are associated, data of transmitted and received e-emails, Web data downloaded through Web browsing, downloaded contents data and the like. The memory 34 may be further configured to temporarily store streaming data and the like.

The external input/output unit 40 serves as an interface to an external apparatus coupled to the smartphone 10. The smartphone 10 is connected to another external apparatus directly or indirectly through communication via the external input/output unit 40. The external input/output unit 40 is configured to convey data received from an external apparatus to a component within the smartphone 10 and transmit internal data in the smartphone 10 to an external apparatus.

Examples of device for communication and the like include universal serial bus (USB), Institute of Electrical and Electronics Engineers (IEEE) 1394, the Internet, wireless local area network (LAN), Bluetooth (registered trademark), radio frequency identification (RFID), and infrared-ray communication. Also, examples of the external apparatus include a headset, external charger, a data port, an audio apparatus, a video apparatus, a smartphone, a PDA, a personal computer, and an earphone.

The GPS receiving unit 42 is configured to detect a location of the smartphone 10 based on positioning information from GPS satellites ST1, ST2, . . . , STn.

The power supply unit 44 is a power supply source configured to supply power to components of the smartphone 10 through a power supply circuit, not shown. The power supply unit 44 includes a lithium ion secondary battery. The power supply unit 44 may include an AC/DC converting unit configured to generate DC voltage from an external AC power supply.

The smartphone 10 configured as described above is set to an image-capturing mode (imaging mode) in response to an instruction input from a user through the touch panel display 14 or the like so that a moving image and a still image can be captured by the in-camera 20 and the out-camera 22.

When set to an imaging mode, the smartphone 10 becomes an imaging standby state in which a moving image is captured by the in-camera 20 or the out-camera 22, and the captured moving image is displayed as a live-view image on the touch panel display 14.

A user visually checks the live-view image displayed on the touch panel display 14 so that the user can determine its composition, check a subject to be captured, and set a imaging condition.

When the smartphone 10 is instructed to perform imaging via an instruction input from a user using the touch panel display 14 or the like in the imaging standby state, the smartphone 10 performs autofocus (AF) control and auto exposure (AE) control, and captures and stores a moving image and a still image.

The memory 34 is an example of the “storage (storin unit)” in the present disclosure. The touch panel display 14 is an example of a user interface and is an example of the “display” in the present disclosure. Each of the in-camera 20 and the out-camera 22 is an example of the “camera” in the present disclosure.

### Functional Configuration of Drug Identification Apparatus

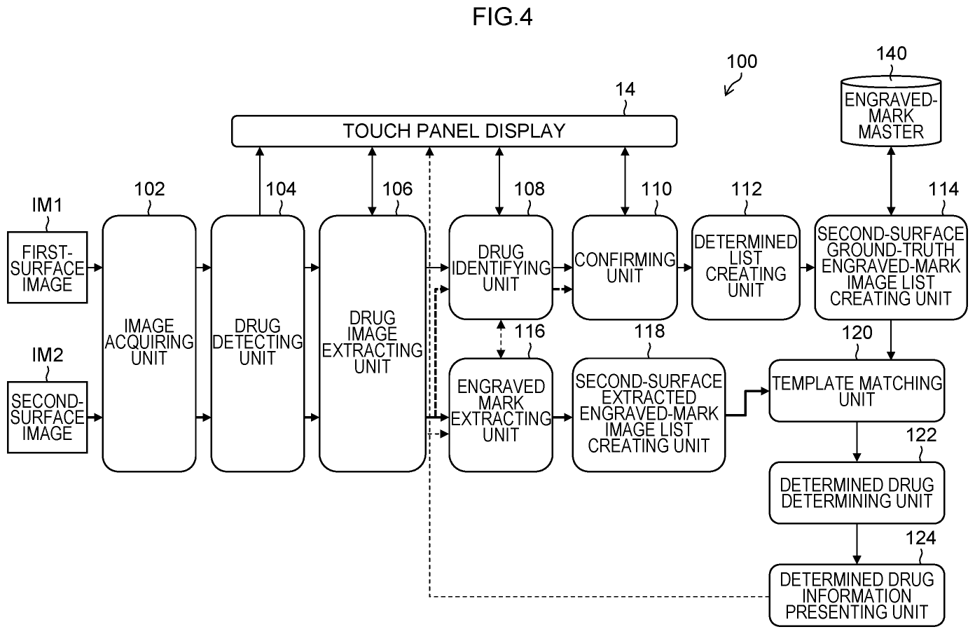

FIG. 4 is a block diagram showing a functional configuration of the drug identification apparatus 100 implemented by the smartphone 10. As shown in FIG. 4, the drug identification apparatus 100 includes an image acquiring unit 102, a drug detecting unit 104, a drug image extracting unit 106, a drug identifying unit 108, a confirming unit 110, a determined list creating unit 112, a second-surface ground-truth engraved-mark image list creating unit 114, an engraved mark extracting unit 116, a second-surface extracted engraved-mark image list creating unit 118, a template matching unit 120, a determined drug determining unit 122, a determined drug information presenting unit 124, the touch panel display 14, and an engraved-mark master 140. Each function of the drug identification apparatus 100 can be implemented by hardware and software in the smartphone 10 and can be embodied by the CPU 28 executing a program stored in the memory 34.

The image acquiring unit 102 acquires a captured image that is a still image acquired by imaging a package (unit-dose package or one-dose package) in which drugs are accommodated in a packaging bag by one dose packaging. The captured image may be an image captured by, for example, the out-camera 22. Also, the captured image may be an image acquired from another apparatus via the wireless communication unit 30, the external storage unit 38, or the external input/output unit 40. The packaging bag may be transparent or translucent, entirely or partially. Each of drugs accommodated in the packaging bag may be an identification target drug (drug to be identified).

The captured image acquired by the image acquiring unit 102 may be an image acquired by capturing one or more markers along with the package. Each of the markers may be, for example, an ArUco marker, a circle marker, a square marker, or the like. In a case where image processing such as image-region cutout processing and/or transforming processing is performed on the captured image, markers are preferably included within the captured image. The markers are arranged at, for example, four corners of a rectangular region in a drug mounting range where drugs are mounted in a surface on which the package is mounted when performing imaging. For example, the drug mounted range is preferably configured to be a gray-colored or black-colored background as a reference.

Further, the captured image may be an image acquired by capturing with a standard capturing distance and capturing viewpoint. The capturing distance can be represented by a distance between an identification target drug (drug to be identified) and an imaging lens, and a focal length of the imaging lens. In addition, the capturing viewpoint can be represented by an angle formed by a drug mounting surface (marker printed surface) and an optical axis of the imaging lens.

When imaging the package, an imaging auxiliary tool may be used so as to set the smartphone 10 to be used, at a camera position with a standard capturing distance and capturing viewpoint or in the vicinity of the camera position. The imaging auxiliary tool is preferably configured by combining a mount on which the package to be imaged is mounted and a lighting device that illuminates the package.

The image acquiring unit 102 may include an image correcting unit, not shown. When markers included in the captured image, the image correcting unit performs standardization of the capturing distance and capturing viewpoint of the captured image based on the markers to generate a standardized image. The standardized image may be an image acquired by performing standardization processing on the captured image and then extracting an inner region of a rectangle having, as its vertices, markers at four corners of the rectangle. For example, the image correcting unit designates destination coordinates of the four vertices of the rectangle, whose coordinates are specified by the markers, after the standardization of the capturing distance and the capturing viewpoint. The image correcting unit acquires a perspective transform matrix such that the four vertices are transformed to respective positions of designated coordinates. Such a perspective transform matrix is defined uniquely if there are four points. For example, getPerspectiveTransform function of open source computer vision library (Open CV) allows acquisition of a transform matrix if a correspondence relationship among the four points is available.

The image correcting unit performs perspective transform on the entire original captured image using the acquired perspective transform matrix, to acquire an image after the transform. Such perspective transform can be executed by using the warpPerspective function of OpenCV. The image after the transform may be a standardized image with the standardized capturing distance and capturing viewpoint.

Also, when a region in gray color as a reference color is included in the captured image, the image correcting unit may perform tone correction on the captured image based on the reference gray color.

In the drug identification apparatus 100 according to the embodiment, firstly acquires a first-surface image IM1 which is a captured image being a still image acquired by imaging a first surface that is a surface on one side of a package. Then, the drug identification apparatus 100 determines a drug type of a drug whose drug-identifiable surface is shown (captured) in the first-surface image IM1, among drugs included in the first-surface image IM1. The term drug-identifiable surface refers to a surface of a drug on which an engraved mark or a print is given, and a drug is identifiable from information of the engraved mark or print given on the surface (surface from which a drug type can be determined). On the other hand, a surface having an engraved mark or a print representing information from which it is difficult to identify a drug or a surface (plane surface) with no engraved mark or the like given is called a hard-to-identify-drug surface. For a drug whose drug-identifiable surface is shown in the first-surface image IM1, its drug type can be determined from the first-surface image IM1.

Then, the drug identification apparatus 100 acquires a second-surface image IM2 which is a captured image being a still image acquired by imaging a second surface on the opposite side of the first surface of the same package, and determines a drug type of a remaining (undetermined) drug by using the second-surface image IM2.

Each of the first-surface image IM1 and the second-surface image IM2 acquired through the image acquiring unit 102 may be a standardized image.

The drug detecting unit 104 detects a region of each drug from the captured images acquired through the image acquiring unit 102. The drug detecting unit 104 may be configured using trained artificial intelligence (AI) model which is trained by machine learning so as to perform a so-called object detection task. A detection result from the drug detecting unit 104 is displayed on the touch panel display 14. For example, a drug region detected from the first-surface image IM1 may be displayed in a bounding box on a screen displaying the first-surface image IM1.

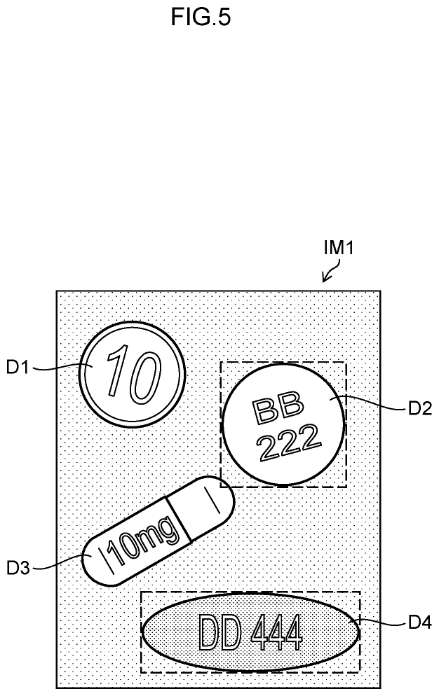

FIG. 5 shows an example of the first-surface image IM1. Four drugs D1 to D4 are shown on the first-surface image IM1 in FIG. 5. In the first-surface image IM1 exemplified in FIG. 5, the drugs D2 and D4 enclosed within dotted line rectangles each has an engraved mark providing great amount of information from which its drug type can be determined. On the other hand, the drugs D1 and D3 each has an engraved mark or print providing less amount of information from which it is difficult to identify the drug in the first-surface image IM1. In other words, the first-surface image IM1 exemplarily shown in FIG. 5 is an image showing a mixture of the drugs D2 and D4 whose drug-identifiable surfaces are imaged, and the drugs D1 and D3 whose hard-to-identify-drug surfaces are imaged.

A user can designate the drugs D2 and D4 whose drug-identifiable surfaces are imaged from the first-surface image IM1 displayed on the touch panel display 14, and perform an operation for determining a drug type of each of the drugs D2 and D4. It should be noted that, without waiting for the drug designation operation by a user, processing by the drug image extracting unit 106 and the drug identifying unit 108 may be performed automatically on each of the drugs detected by the drug detecting unit 104.

The drug image extracting unit 106 extracts an image region of each of drugs from the captured image based on the detection result by the drug detecting unit 104 and generates a drug image which is an image region cutout for each drug.

It should be noted that the drug image extracting unit 106 may be incorporated in the drug detecting unit 104. For example, the drug detecting unit 104 may include a drug region extraction model. The drug region extraction model may be a trained model that receives a captured image acquired by imaging a drug as input, and outputs a drug image in a drug region extracted from the captured image. The drug region extraction model may be a segmentation model having undergone machine learning with a learning dataset of different captured images. In the learning dataset, each set includes an image of a drug; and a region of the drug included in the image. As a drug region extraction model, a convolution neural network (CNN) may be applied.

The drug identifying unit 108 is a processing unit that identifies a drug type of a drug from the drug image extracted by the drug image extracting unit 106. The drug identifying unit 108 may be an AI processing unit which employs a trained AI model (drug identification model) trained by machine learning so as to perform an object recognition task to identify a type of a drug from an input drug image, for example. The type of a drug to be identified by the drug identifying unit 108 is a drug type that can be determined based on an identification information, for example, YJ code (individual drug code), a drug name, or the like. The drug identification according to the embodiment may be defined as an action that determines YJ code of a drug corresponding to the identification target drug. This is just an example of the definition of the drug identification. For example, an identification code may be defined by using a type other than YG code.

The drug identification model functions as a multiclass classifier configured to receive input of a drug image of an identification target drug, identify a type of the drug, and classify the drug into one of learned N types of drug types (classes). When the drug identification model receives input of a drug image, the drug identification model calculates score values indicating accuracies (certainty factors) that the identification target drug is a drug i for each drug i of all the learned N types of drugs. The letter “i” in the notation “drug i” refers to an index for distinguishing each drug in the learned N types of drugs. For each drug i, the drug identification model calculates a score value serving as an indicator for determining whether the identification target drug is a drug i.

The drug identification model is configured by using, for example, a neural network. As a machine learning model preferable for image recognition, a CNN can be used. The image to be input to the drug identification model may be a region image (drug image) of the identification target drug, which is cut out from the captured image. Note that, in addition to the drug image, identification mark information such as the engraved mark or print extracted from the drug image may be input to the drug identification model. The identification mark information may be an image or text information.

Based on the identification result by the drug identifying unit 108, one or more candidates for a drug type having higher score values are displayed on the touch panel display 14.

For example, when a user designates an identification target drug (drug D2, for example) on the first-surface image IM1, a drug image of the identification target drug relating to the designation is extracted from the first-surface image IM1 and is input to the drug identifying unit 108, and candidates for a drug type are displayed as an identification result by the drug identifying unit 108, on the touch panel display 14.

The confirming unit 110 is configured to receive an instruction to confirm a drug type of the target drug from the touch panel display 14 or another user interface, and perform processing for confirming the drug type of the target drug in response to the received instruction. Thus, the drug type of the target drug is determined.

When the drug type of the target drug is determined, the front or back of the target drug is also determined as a result. For example, when a drug whose drug type is determined from the first-surface image IM1, because it can be understood that a drug-identifiable surface of the drug is captured in the first-surface image IM1, the drug-identifiable surface may be identified as a “front”. Also, for example, with reference to the engraved-mark master 140 based on the determined drug type, the front or back of the drug can be determined.

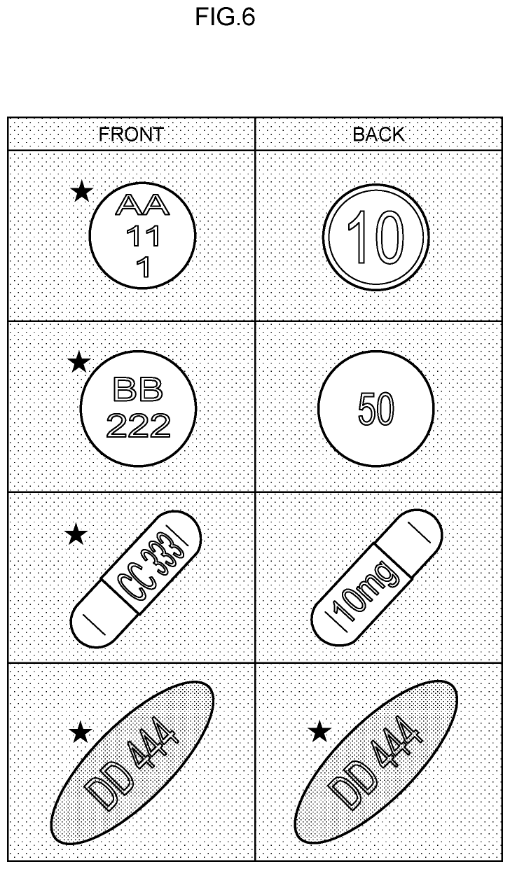

The engraved-mark master 140 is a master database including image information on an engraved mark or print given to a drug. The engraved-mark master 140 stores an image of the identification mark engraved or printed on each of the front surface and the back surface of the drug, in association with a drug type of the drug (see FIG. 6). The engraved-mark master 140 is recorded in the memory 34, and data stored in the engraved-mark master 140 is updated as needed. In determining the front or back of the drug, template matching may be performed between a drug image extracted from the first-surface image IM1 or an extracted engraved-mark image extracted from the drug image, and the engraved-mark master 140.

Further, the drug identification model may be a model trained so as to be capable of receiving input of a one-side image acquired by imaging an identification target drug from one surface side (from one direction), and identifying a drug type of the identification target drug and further identifying the front or back of the identification target drug (identifying whether the side captured in the image is the front or the back of the drug). For example, the drug identification model may be a class classifier trained by machine learning so as to receive input of a drug image and output a class containing a combination between a YJ code and information indicating front or back. By employing such a model, the front or back of the drug can be identified at a timing when a drug type of the drug is identified. In this case, there is no need for the model to define classes for all the combinations between YJ codes and information indicating the front or back. It is possible to use a model which does not define classes for combinations containing a hard-to-identify-drug surface.

In order to improve accuracy in identification by the drug identification model, the template matching with the engraved-mark master 140 may be further used to determine the front or back of the drug.

After the drug detection id performed for the first-surface image IM1, the user checks the identification result by the drug identifying unit 108 for the first-surface image IM1, and determines a drug type, and the front or back. In a case shown in FIG. 5, the user performs an operation for determining a drug type of each of the drugs D2, D4. It should be noted that the user may determine a drug type by performing text search, for example, through an engraved mark database (not shown) based on information of the engraved mark or print on the drug that can be visually recognized from the first-surface image IM1 and utilizing the search result, instead of using the identification processing by the drug identifying unit 108. The engraved mark database is a collection of data in which a string of an engraved mark or print given on a drug and a drug type of the drug to which the engraved mark or print of the string are given, in a manner associated with each other. The engraved mark database may be configured integrally with the engraved-mark master 140.

The determined list creating unit 112 creates a list (hereinafter, referred to as “determined list”) of determined drugs that are drugs whose drug types have been determined from the first-surface image IM1, through processing by the confirming unit 110. In the example shown in FIG. 5, the determined list is created so as to include information indicating that the drugs D2 and D4 are determined drugs. The determined list includes a YJ code and information regarding the front or back, for each determined drug whose drug type has been determined from the first-surface image IM1.

The second-surface ground-truth engraved-mark image list creating unit 114 creates from the determined list and the engraved-mark master 140, a second-surface ground-truth engraved-mark image list that is a list of an ground-truth engraved-mark image (ground-truth of engraved-mark image) on the second surface side of each determined drug. Here, the “ground truth engraved-mark image” means an engraved-mark image expected to appear on the second surface and is an engraved-mark image as an expected value of the second surface. By reversing the front and back of each of the determined drugs determined from the first-surface image IM1, a second-surface ground-truth engraved-mark image list may be created from the engraved-mark master 140.

It should be noted that the “engraved mark” in the terms of “engraved-mark master 140”, “engraved mark database” and “engraved-mark image”, is representative of the concept of the identification mark provided by at least one of engraving and printing. Thus, the “engraved mark” embraces meaning of “engraved mark and/or print”. The term “engraving/engraved” herein may be understood as including the concept of “printing/printed”, as long as there is no inconsistency.

FIG. 6 shows an example of the engraved-mark master 140. FIG. 6 illustrates engraved-mark images registered with the engraved-mark master 140 for the drugs D1 to D4. Here, although only four drugs D1 to D4 are shown, the engraved-mark master 140 may include data regarding all identifiable types of drugs.

In FIG. 6, an image to which a star is attached indicates that it is an image of the drug-identifiable surface of a drug. It should be noted that the drug having an engraved mark “DD 444” thereon shown at the bottom of FIG. 6 has the same engraved mark on both of its front side and back side, so that both of the front surface and the back surface are drug-identifiable surfaces. The engraved-mark master 140 shown in FIG. 6 is an example of the “identification mark master” in the present disclosure and each engraved-mark image shown in FIG. 6 is an example of the “identification mark image (image of identification mark)” in the present disclosure.

The second-surface ground-truth engraved-mark image list creating unit 114 refers to the engraved-mark master 140 based on the determined list, extracts the engraved-mark image on the second surface side for each determined drug from the engraved-mark master 140, and creates the second-surface ground-truth engraved-mark image list.

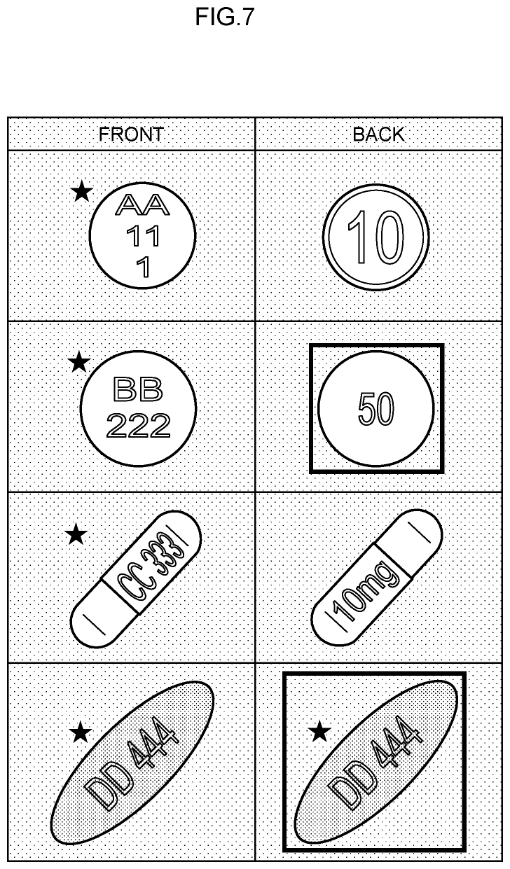

FIG. 7 is an explanatory diagram showing an example in which the engraved-mark image on the second surface side of each determined drug is determined from the engraved-mark master 140. When the drugs D2 and D4 are determined drugs in the example in FIG. 5, the engraved-mark images on the back surfaces of the drugs D2 and D4 are respectively enclosed with thick-line rectangles in FIG. 7. In other words, as to the determined drug D2 having “BB 222” as an engraved mark on the front surface, an engraved mark expected to appear on the second-surface image IM2 of the drug D2 is an engraved mark of “50”. Also, as to the determined drug D4 having “DD 444” as an engraved mark on the front surface, an engraved mark expected to appear on the second-surface image IM2 of the drug D4 is an engraved mark of “DD 444”.

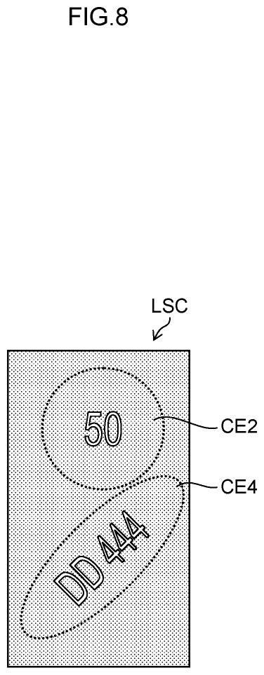

In this way, for each of the determined drugs, a ground truth of the engraved-mark image expected to appear on the second-surface image IM2 is retrieved from the engraved-mark master 140, and the second-surface ground-truth engraved-mark image list is collectively created based on the retrieved engraved-mark images (see FIG. 8).

FIG. 8 shows an example of the second-surface ground-truth engraved-mark image list LSC. The second-surface ground-truth engraved-mark image list LSC shown in FIG. 8 includes ground truth engraved-mark images CE2, CE4 (as expected values) which should respectively appear on the second surface sides of the determined drugs D2, D4 illustrated in FIG. 7. These ground truth engraved-mark images CE2, CE4 are extracted from the engraved-mark master 140 using the determined list. Each of the engraved-mark images CE2, CE4 is an example of the “identification mark image” in the present disclosure, and the second-surface ground-truth engraved-mark image list LSC is an example of the “second-surface ground-truth identification mark image list” in the present disclosure. The second-surface ground-truth engraved-mark image list LSC is used as a matching list to be applied to the template matching unit 120, when a type of each remaining (undetermined) drug is determined using the second-surface image IM2.

Next, processing on the second-surface image IM2 is described.

After the operation for determining a drug from the first-surface image IM1 is completed, a user inverts the same package and captures an image of the second surface.

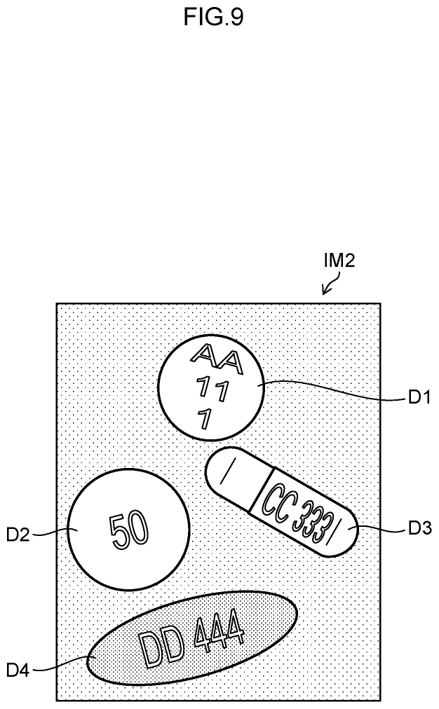

FIG. 9 shows an example of the second-surface image (image of the second surface) IM2. The second-surface image IM2 shown in FIG. 9 is an example of an image which is captured in a state where the same package as the first-surface image IM1 shown in FIG. 5 is inverted. In the second-surface image IM2 shown in FIG. 9, drug-identifiable surfaces of the drugs D1 and drug D3 are imaged.

The image acquiring unit 102 acquires the second-surface image IM2. Like the first-surface image IM1, drug regions are detected from the second-surface image IM2 by the drug detecting unit 104. The drug image extracting unit 106 creates a drug image that is a cut-out image of each drug detected by drug detection processing. The engraved mark extracting unit 116 extracts an engraved mark from a drug image of each drug extracted from the second-surface image IM2 and creates an extracted engraved-mark image of each drug.

The second-surface extracted engraved-mark image list creating unit 118 creates a second-surface extracted engraved-mark image list which collectively includes extracted engraved-mark images of drugs each extracted from the second-surface image IM2.

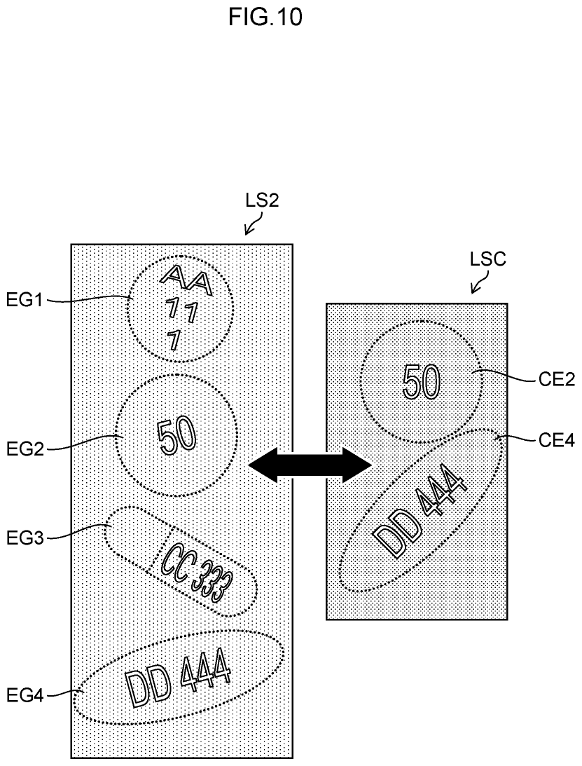

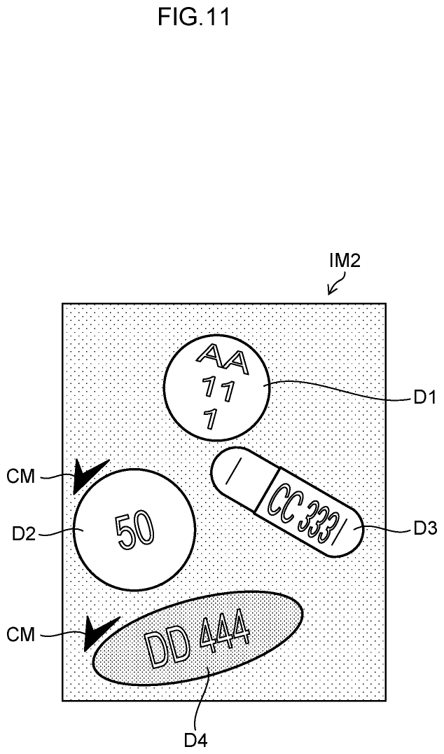

An example of the second-surface extracted engraved-mark image list LS2 is shown on the left side of FIG. 10. The second-surface extracted engraved-mark image list LS2 is created from the second-surface image IM2 shown in FIG. 9. The second-surface extracted engraved-mark image list LS2 includes extracted engraved-mark images EG1, EG2, EG3, EG4 extracted respectively from drug images of the drugs D1, D2, D3, D4 which are included in the second-surface image IM2. Each of the extracted engraved-mark images EG1 to EG4 is an example of the “extracted identification-mark image” in the present disclosure, and the second-surface extracted engraved-mark image list LS2 is an example of the “extracted identification-mark image list” in the present disclosure.

The template matching unit 120 performs round-robin template matching between the extracted engraved-mark images EG1 to EG4 included in the second-surface extracted engraved-mark image list LS2 and the engraved-mark images CE2, CE4 each being a ground truth included in the second-surface ground-truth engraved-mark image list LSC, and evaluates a degree of matching therebetween for each matching. The evaluation of the degree of matching is performed based on a matching score calculated through the template matching. The template matching is an example of the “pattern matching” in the present disclosure. FIG. 10 shows that the template matching processing is performed between the engraved-mark images in the second-surface ground-truth engraved-mark image list LSC and engraved-mark images in the second-surface extracted engraved-mark image list LS2.

The determined drug determining unit 122 determines, as a determined drug, the engraved-mark image having a high degree of matching with the second-surface ground-truth engraved-mark image list LSC, from the second-surface extracted engraved-mark image list LS2 based on the processing result by the template matching unit 120.

In the example shown in FIG. 10, the extracted engraved-mark image EG2 and the extracted engraved-mark image EG4 are evaluated as having higher degrees of matching with the ground truth engraved-mark images CE2, CE4 in the second-surface ground-truth engraved-mark image list LSC, and the drugs D2, D4 corresponding to those extracted engraved-mark images EG2, EG4 are determined as determined drugs in the second-surface image IM2.

The determined drug information presenting unit 124 presents a user, information for differentiating the determined drugs whose drug types have been determined and an undetermined drugs whose drug types have not been determined, among the drugs D1 to D4 in the second-surface image IM2, based on the information on the determined drugs determined by the determined drug determining unit 122.

FIG. 11 is a diagram showing a presentation example of information for differentiating determined drugs from undetermined drugs in the second-surface image IM2. In FIG. 11, a checkmark CM indicating that the drug type has been determined is given to each of the drug D2 and the drug D4 which are the determined drugs. A user can understand whether or not a drug type has been determined for each drug, based on the presence of the checkmark CM. In other words, the user can easily recognize that the drugs D2, D4, to which the checkmarks CM are added, are determined drugs, and can realize that the remaining drugs D1, D3, to which the checkmarks CM are not added, need identification processing.

According to such a configuration, since a drug whose drug type has been determined from the first-surface image IM1 can be determined in the second-surface image IM2, a user can easily understand a remaining drug to be identified in the second-surface image IM2.

The checkmark CM is an example of the “information for differentiating” in the present disclosure. In FIG. 11, although the example is shown in which the information indicating “determined” is given to the determined drug, the information indicating “undetermined” may be given to the undetermined drug, instead of or in combination with that. Further, an aspect of the differentiation should not be limited to the presence of the checkmark CM. Examples of the differentiation may include: the presence of a frame such as a bounding box having a drug therein; difference in display color of the frame; difference in shape of the frame; difference between flashing display and normal display of a mark or the like; display of text information informing that it is determined or undetermined; grayed out display of a determined drug; and a proper combination these examples.

### Examples of Drug Identification Method

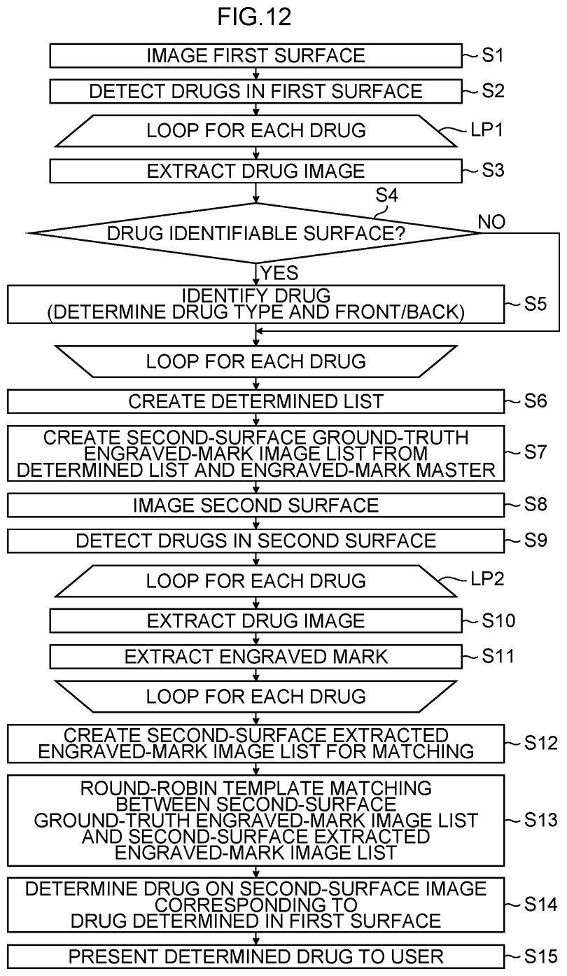

FIG. 12 is a flowchart showing an example of a drug identification method to be implemented by employing the drug identification apparatus 100 according to the embodiment.

In step S1, a user captures an image of a first surface being a surface on one side of a package, with a camera of the smartphone 10 (for example, the out-camera 22). The CPU 28 acquires the first-surface image IM1 obtained by imaging the first surface of the package.

In step S2, the CPU 28 detects drugs from the first-surface image IM1. For example, processing for detecting drugs may be executed by a drug detection artificial intelligence (AI) employing a trained model that extracts regions of drugs from the captured image input to the model.

Then, the CPU 28 moves to a first loop LP1. The first loop LP1 includes step S3 to step S5. The CPU 28 executes step S3 to step S5 for each drug detected in step S2.

In step S3, the CPU 28 cuts out a region of each of the detected drugs from the first-surface image IM1 and extracts a drug image that is a region image for each drug.

In step S4, the CPU 28 determines whether or not the extracted drug image is an image of an identifiable surface from which a drug type can be identified. For example, a user checks engraved mark information on the display screen of the first-surface image IM1 and performs an operation for designating the drugs D2, D4 having great amount of information so that surfaces of the designated drugs D2, D4 may be determined as their “drug-identifiable surfaces”.

In a case where the determination result of step S4 is Yes, the processing moves to step S5.

In step S5, the CPU 28 executes processing of drug identification on a drug to be identified, and determines a drug type and the front and back through a confirmation operation by a user.

On the other hand, in a case where the determination result of step S4 is No, the processing skips step S5.

The first loop LP1 is executed for each of drugs detected from the first-surface image IM1 so that the drug type and the front and back are determined for each drug whose drug-identifiable surface is imaged in the first-surface image IM1. When the CPU 28 completes processing of the first loop LP1 for each of the drugs included in the first-surface image IM1 and exits the first loop LP1, the processing moves to step S6.

In step S6, the CPU 28 creates a determined list that is a list of drugs whose drug types have been determined from the first-surface image IM1.

In step S7, the CPU 28 creates a second-surface ground-truth engraved-mark image list from the determined list and the engraved-mark master 140.

In step S8, a user inverts the package and images a second surface of the package with the camera of the smartphone 10. The CPU 28 acquires a second-surface image IM2 obtained by imaging the second surface of the package.

In step S9, the CPU 28 performs drug detection processing on the acquired second-surface image IM2. Step S9 may be processing similar to step S2.

Then, the CPU 28 moves to a second loop LP2. The second loop LP2 includes step S10 and step S11. The CPU 28 executes step S10 and step S11 for each drug detected in step S9.

In step S10, the CPU 28 cuts out a region of each of the detected drugs from the second-surface image IM2 and extracts a drug image that is a region image for each drug.

In step S11, the CPU 28 extracts an engraved mark from each drug image extracted in step S10.

When the CPU 28 completes processing of the second loop LP2 for each of the drugs included in the second-surface image IM2 and exits the second loop LP2, the processing moves to step S12.

In step S12, the CPU 28 creates a second-surface extracted engraved-mark image list for matching, that is a list of the extracted engraved-mark images extracted by the second loop LP2.

In step S13, the CPU 28 performs round-robin template matching between engraved-mark images in the second-surface ground-truth engraved-mark image list and engraved-mark images in the second-surface extracted engraved-mark image list.

In step S14, the CPU 28 determines which drug in the second-surface image IM2 corresponds to the drug (determined drug) whose drug type has been determined from the first surface, based on the processing result in step S13.

In step S15, the CPU 28 clearly presents which drug in the second-surface image IM2 is the determined drug based on the determination result in step S14, to a user. For example, as in FIG. 11, the CPU 28 presents determined drugs and undetermined drugs in a state where checkmarks CM are attached to the determined drugs, so as to differentiate the determined drug from the undetermined drugs.

After step S15, the same processing as that of the first loop LP1 is performed on an undetermined drug on the second-surface image IM2 to determine a drug type of the undetermined drug.

### Hardware Configuration of Processing Units

The hardware structure of the processing units that execute various kinds of processing such as the image acquiring unit 102, drug detecting unit 104, drug image extracting unit 106, drug identifying unit 108, confirming unit 110, determined list creating unit 112, second-surface ground-truth engraved-mark image list creating unit 114, engraved mark extracting unit 116, second-surface extracted engraved-mark image list creating unit 118, template matching unit 120, determined drug determining unit 122, and determined drug information presenting unit 124 described with reference to FIG. 4 may be various kinds of processors as described below.

The various processors include: a central processing unit (CPU) that is a general purpose processor which executes programs and functions as various processing units; a graphics processing unit (GPU) that is a processor dedicated to image processing; a programmable logic device (PLD) that is a processor having a circuit configuration changeable after manufactured, such as a field programmable gate array (FPGA); and a dedicated electric circuit that is a processor having a circuit configuration specially designed for executing specific processing such as application specific integrated circuit (ASIC).

One processing unit may be configured by one of those various processors, or may be configured by two or more processors of the same kind or of different kinds. For example, one processing unit may be configured by FPGAs, a combination of a CPU and an FPGA, a combination of a CPU and a GPU, or the like. Also, processing units may be configured by one processor. As an example in which processing units are configured by one processor, firstly, there is an aspect in which one processor is configured by a combination of one or more CPUs and software, as typified by computers such as a client and a server, and the processor functions as processing units. Secondly, there is an aspect which employs a processor having an integrated circuit (IC) chip to implement functionality of an entire system including processing units, as typified by a system on chip (SoC) or the like. In this way, various processing units may be configured by employing one or more of the various processors as described above as the hardware structure.

Further, a hardware structure of those various processors may be, more specifically, an electric circuitry in which circuit elements such as semiconductor elements are combined.

### Program Implementing Functionality of Drug Identification Apparatus 100

The processing functions of the drug identification apparatus 100 should not be limited to the smartphone 10. The processing functions of the drug identification apparatus 100 may be implemented by information devices in various forms such as a tablet type computer, a personal computer, a workstation, or a server. The processing functions of the drug identification apparatus 100 may be implemented by a computer system including a plurality of computers. The processing functions of the drug identification apparatus 100 may be implemented by employing a cloud server.

A program for causing a computer to implement some or all of the processing functions of the drug identification apparatus 100 described in the embodiment may be recorded in a computer-readable medium that is a tangible, non-transitory information storage medium such as an optical disk, a magnetic disk, a semiconductor memory or the like. Through this information storage medium, the program may be provided. Instead of the aspect in which a program is stored in such a tangible, non-transitory information storage medium, an electric communication line such as the Internet may be utilized to provide a program signal as a download service.

Also, some or all of the processing functions of the drug identification apparatus 100 may be provided as an application server, and a service may be performed for providing the processing functions through an electric communication line.

### Effects of Embodiments

The drug identification apparatus 100 according to the embodiment achieves effects as follows.
[1] The drug identification apparatus 100 may automatically determine which drug in the second-surface image of a package corresponds to the drug whose drug type has been determined from the first-surface image IM1 of the package.
[2] In a case where drug types of some of the drugs in the first-surface image IM1 are determined from the first-surface image IM1 and then remaining undetermined drugs are identified on the second-surface image IM2, the drug identification apparatus 100 may present the second-surface image IM2 to a user, in such a manner that the determined drugs and the undetermined drugs are clearly differentiated from each other in the second-surface image IM2.
[3] A user can easily understand on which drug the drug identification processing is to be performed among drugs in the second-surface image IM2. Thus, the work load for identifying packaged drugs can be reduced, and the efficiency of the work can be improved.

### Variation Example 1

The aforementioned embodiment describes the example in which drug types of some of the drugs in the first-surface image IM1 are determined from the first-surface image IM1 and then the second-surface image IM2 is acquired. However, the timings for acquiring the first-surface image IM1 and the second-surface image IM2 are not limited to the example. For example, after imaging the first surface, then the second surface is imaged, and after the first-surface image IM1 and the second-surface image IM2 are acquired, the drug identification may be performed on the first-surface image IM1.

The order of the imaging of the first surface and the second surface is not particularly limited to the example. For example, an image that is firstly imaged may be handled as the second-surface image, and an image that is subsequently imaged may be handled as the first-surface image.

### Variation Example 2

In another embodiment, a package may be imaged by using the smartphone 10, then the captured image may be transmitted to a server so that the processing in step S2 to S7 and step S9 to S15 in FIG. 12 is performed on the server, and the processing result may be returned to the smartphone 10.

### Variation Example 3

The embodiment describes the case where a drug is discriminated, the technology of the present disclosure may be also applicable to a case where drug audit is to be performed.

### Others

The technical scope of the present invention is not limited to the scopes described in the embodiments and variation examples above. Configurations and the like in the embodiments and the variation examples may be modified without departing from the spirit of the present invention, and may be combined as appropriate between or among the embodiments and the variation examples.

### REFERENCE SIGNS LIST

10 smartphone
12 housing
14 touch panel display
16 speaker
18 microphone
20 in-camera
22 out-camera
24 light
26 switch
28 CPU
30 wireless communication unit
32 talking unit
34 memory
36 internal storage unit
38 external storage unit
40 external input/output unit
42 GPS receiving unit
44 power supply unit
100 drug identification apparatus
102 image acquiring unit
104 drug detecting unit
106 drug image extracting unit
108 drug identifying unit
110 confirming unit
112 determined list creating unit
114 second-surface ground-truth engraved-mark image list creating unit
116 engraved mark extracting unit
118 second-surface extracted engraved-mark image list creating unit
120 template matching unit
122 drug determining unit
124 drug information presenting unit
140 engraved-mark master
CE2, CE4 engraved-mark image
CM checkmark
D1, D2, D3, D4 drug
EG1, EG2, EG3, EG4 extracted engraved-mark image
IM1 first-surface image
IM2 second-surface image
LS2 second-surface extracted engraved-mark image list
LSC second-surface ground-truth engraved-mark image list
ST1, ST2, STn GPS satellite
LP1 first loop in drug identification method
LP2 second loop in drug identification method
S1-S15 steps of drug identification method

What is claimed is:

1. A drug identification apparatus comprising:
one or more processors; and
one or more storage devices,
wherein the one or more storage devices are configured to store an identification mark master including an image of an identification mark on each of a front surface and a back surface, for each drug having the identification mark formed by engraving or printing thereon, and
wherein the one or more processors are configured to:
detect each drug, from a first-surface image acquired by imaging a first surface of a package accommodating drugs in a packaging bag;
create, from the identification mark master by using information on a determined drug which is at least one of the drugs, and whose drug type and a front surface and a back surface have been determined based on a drug image extracted for each drug from the first-surface image, a second-surface ground-truth identification mark image list including an identification mark image showing an identification mark of the determined drug appearing on a second surface being a back surface of the first surface of the package;
detect each drugs from a second-surface image acquired by imaging the second surface of the package;
extract an identification mark of each drug from the second-surface image, and create an extracted identification-mark image list including an extracted identification-mark image for each drug;
determine the determined drug in the second-surface image by performing pattern matching using the second-surface ground-truth identification mark image list and the extracted identification-mark image list; and
present on the second-surface image, information for differentiating the determined drug from a undetermined drug whose drug type has not been determined.

2. The drug identification apparatus according to claim 1,
wherein the one or more processors are configured to identify the drug type and the front surface and the back surface for the at least one of the drugs, using a drug identification model trained by machine learning to identify a drug type and a front surface and a back surface from the drug image.

3. The drug identification apparatus according to claim 1,
wherein the one or more processors are configured to:
identify the drug type for the at least one of the drugs, using a drug identification model trained by machine learning to identify a drug type from the drug image; and
determine the front surface and the back surface for the at least one of the drugs, using the identification mark master.

4. The drug identification apparatus according to claim 3,
wherein the one or more processors are configured to determine a front surface and a back surface by pattern matching between the drug image or an identification mark image extracted from the drug image, and the identification mark master.

5. The drug identification apparatus according to claim 1,
wherein the one or more processors are configured to:
perform round-robin pattern matching between the identification mark images in the second-surface ground-truth identification mark image list and the extracted identification-mark images in the extracted identification-mark image list; and
determine the determined drug in the second-surface image based on a matching score.

6. The drug identification apparatus according to claim 1, wherein the pattern matching is template matching.

7. The drug identification apparatus according to claim 1,
wherein the one or more processors are configured to:
receive input of an instruction to confirm the drug type identified for the at least one of the drugs; and
determine the drug type of a target drug based on the input of the instruction.

8. The drug identification apparatus according to claim 1,
wherein the one or more processors are configured to create a determined list as information on the determined drug.

9. The drug identification apparatus according to claim 1,
wherein the one or more processors are configured to add to the determined drug in the second-surface image, a mark as the information for differentiating so as to present that its drug type has been determined.

10. The drug identification apparatus according to claim 1,
wherein the one or more processors are configured to add to the undetermined drug in the second-surface image, a mark as the information for differentiating so as to present that its drug type has not been determined.

11. The drug identification apparatus according to claim 1, further comprising
a display configured to display the second-surface image including the information for differentiating.

12. The drug identification apparatus according to claim 1, further comprising
a camera configured to image the package.

13. A drug identification method to be executed by one or more processors, the method comprising:
causing, in advance, one or more storage devices to store an identification mark master including an image of an identification mark on each of a front surface and a back surface, for each drug having the identification mark formed by engraving or printing thereon;
acquiring a first-surface image acquired by imaging a first surface of a package accommodating drugs in a packaging bag;
detecting each drug from the first-surface image and extracting a drug image for each drug;
determining a drug type and a front surface and a back surface for at least one of the drugs based on the drug image extracted from the first-surface image;
creating, from the identification mark master by using information on a determined drug whose drug type has been determined from the first-surface image, a second-surface ground-truth identification mark image list including an identification mark image showing an identification mark of the determined drug appearing on a second surface being a back surface of the first surface of the package;
acquiring a second-surface image by imaging the second surface of the package;
detecting each drug from the second-surface image to extract an identification mark of each drug, and creating an extracted identification-mark image list including an extracted identification-mark image for each drug;
determining the determined drug in the second-surface image by performing pattern matching using the second-surface ground-truth identification mark image list and the extracted identification-mark image list; and
presenting on the second-surface image, information for differentiating the determined drug from a undetermined drug whose drug type has not been determined.

14. A non-transitory, computer-readable tangible recording medium which records thereon a program for causing, when read by a computer, the computer to implement the drug identification method according to claim 13.
